(19) United States
(12) Patent Application Publication
(10) Pub. No.: US 2010/0319226 A1
(43) Pub. Date: Dec. 23, 2010

(54) Tethered Airborne Advertising system

(76) Inventor: Demir Oral, Rancho Santa Fe, CA (US)

Correspondence Address: JAMES E. BRUNTON, ESQ., P. O. BOX 29000, GLENDALE, CA, 91209, US

(21) Appl. No.: 12/456,451

(22) Filed: Jun. 17, 2009

(51) Int. Cl. G09F 21/06; G09F 21/08; G09F 21/10; G03B 21/00; G03B 31/00

(52) U.S. Cl. 40/214; 353/122; 353/15

(57) ABSTRACT

A tethered airborne advertising system comprises a lifting element and a separate display structure. The lifting element includes, for example, one or more kites or lighter-than-air balloons. The display structure is lifted primarily by the lifting element, exhibits one or more advertising images and may have one or more attention-getting devices affixed to it. In certain embodiments, operation of these advertising images and attention-getting devices can be controlled remotely by way of a signal transmitter and signal receiver. Particular embodiments place the advertising images onto the display structure by way of a ground-based or onboard projector subsystem. The mounted attention-getting devises may include those capable of generating smoke, sound, music, dynamic images, or releasing environmentally friendly confetti or advertising fliers.

### CROSS-REFERENCE TO RELATED APPLICATIONS

Not Applicable.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not Applicable.

### BACKGROUND OF THE INVENTION

1. Field of the Invention

The present invention relates generally to tethered airborne devices. More particularly, the invention concerns a system for lifting and displaying images in an elevated position by use of tethered kites, sails, lighter-than-air balloons and the like.

2. Description of Related Art Including Information Disclosed Under 37 CFR 1.97 and 1.98

Kites, balloons and other tethered lift-generating objects have existed in the prior art for centuries. Their use as tethered advertising vehicles has existed for decades. The advertisement component of the system typically comprises a static printed image displaying text or other graphics associated with a given company, product or service. The printed image is generally directly physically integrated with the element relied upon to produce the majority of the system's lifting force, as, for example, where the image is printed directly on the side of a balloon or the undersurface of a large kite. Other common examples in the prior art propose the attachment of a separate printed banner directly to the side of a balloon or the undersurface of a kite.

Essential to successful advertising is the ability to attract as much attention as possible to the object from which the marketing message emanates. Some prior expedients of tethered advertising systems have, for example, proposed using electronic display means such as LEDs and fiber optics. Other kites exist which have physical features that produce a continuous audible signature as a result of the airflow surrounding the kite while in flight.

There exists a need for a tethered airborne advertising system which allows an advertiser to easily select the desired combination of visual and audio effects to be generated by the advertising system, as well as provide the ability to remotely control and modify when and how those effects are generated even after the system has been deployed skyward. Of particular importance is the need to be able to modify graphic images and audio signals remotely such that advertising messages can be changed at will without disruption of the system's skyward deployment.

### BRIEF SUMMARY OF THE INVENTION

By way of summary, the present invention concerns a tethered airborne advertising system comprising a tether element having a proximal and distal end, the proximal end being releasably restrained at approximately the earth's surface, a lifting element connected to the tether element for providing a lifting force, a display structure typically including a three-dimensional frame and a covering connected to the three-dimensional frame and cooperating therewith to define an internal compartment, and a display portion connected to the display structure for displaying an image viewable from proximate the earth's surface.

In some embodiments, the described lifting element is disposed between the tether element and the display structure. In other embodiments the display structure is disposed between the tether element and the lifting element. Further, in some embodiments the lifting element is comprised of at least one kite, and in others, at least one lighter-than-air balloon. In additional embodiments, the lifting element may comprise multiple kites or balloons, or combinations of both.

Some embodiments further comprise a projection subsystem operably associated with the display portion for projecting the image onto the display portion. The projection subsystem generally includes a projector element which is responsible for projecting the described image onto the display portion. In some embodiments, the projector element is positioned proximate the earth's surface; in others, the projector element is operably affixed to the display structure. In embodiments in which the projector element is operably affixed to the display structure, the projector element may be disposed within the internal compartment, or externally mounted by way of, for example, a mounting boom.

Certain embodiments further include a signal receiver operably associated with the display structure and electrically associated with the projector element, a signal transmitter operably associated with the signal receiver for transmitting to the signal receiver to modify the image, and a power source operably associated with the signal receiver for supplying electrical power thereto. Additional related embodiments further comprise a sound transmission device operably associated with the display structure for supplying power to the sound transmission device.

In some embodiments with a power source, the power source is comprised of at least one solar panel, typically fixedly associated with the display structure. In other embodiments, the power source is comprised of at least one wind-driven generator, typically fixedly associated with the display structure. In certain embodiments with signal transmitters and signal receivers, the signal transmitter may transmit an RF signal to said signal receiver.

Certain other embodiments further comprise an effects interface for electrically communicating with at least one attention-getting device and a power source for providing electrical power to the effects interface. Typically, the effects interface is fixedly associated with the display structure. Examples of such attention-getting devices include a smoke effect device, a confetti release device, a flier release device, a sound transmission device and a visual transmission device. The visual transmission device is generally capable of producing either static or dynamic images, and in some cases both. The sound transmission device is operably connected to the effects interface and operably associated with the signal receiver for transmitting sound detectable to by the unaided human ear at approximately ground level when so commanded by way of the signal receiver. The particular attention-getting device may vary between embodiments, and some embodiments may include multiple such attention-getting devices. Such attention-getting devices are generally each adapted for rapid and removable placement in electrical communication with the effects interface.

### BRIEF DESCRIPTION OF SEVERAL VIEWS OF THE DRAWINGS

Further advantages of the present invention may become apparent to those skilled in the art with the benefit of the following detailed description of the preferred embodiments and upon reference to the accompanying drawings in which:

FIG. 1A is a perspective view of an embodiment of a tethered airborne advertising system in which the lifting element is disposed between the tether element and the display structure.

FIG. 1B is a perspective view of a further embodiment of a tethered airborne advertising system in which the lifting element and the display structure are independently connected to the tether element.

FIG. 2A is a fragmentary side view of an embodiment showing various attention-getting devices and an effects interface affixed to the display structure within the internal compartment.

FIG. 2B is a fragmentary perspective view of the embodiment similar to that depicted in FIG. 2A, further illustrating a signal receiver, signal transmitter and sound transmission device.

FIG. 2C is a fragmentary side view of an embodiment in which a projector element is positioned proximate the earth's surface.

FIG. 2D is a fragmentary perspective view of the embodiment of FIG. 2C.

FIG. 3A is a perspective view of an embodiment in which one projector element is affixed to the support structure internally and a second projector element is affixed to the support structure externally by way of a mounting boom, each projector element projecting a respective image on a separate display portion.

FIG. 3B is a fragmentary side view of the embodiment of FIG. 3A.

FIG. 3C is a fragmentary perspective view of an embodiment similar to the embodiment of FIG. 3A, but including an RF signal transmitter.

FIG. 4 is a fragmentary perspective view of an embodiment in which the display portion is connected to a generally cylindrical display structure.

FIG. 5 is a fragmentary front view of an embodiment in which the lifting element is comprised of two lighter-than-air balloons and the display structure is generally planar.

FIG. 6 is a fragmentary perspective view of an embodiment similar to that depicted in FIG. 5, but in which the display structure is generally cylindrical.

FIG. 7 is a fragmentary perspective view of an embodiment similar to that depicted in FIG. 6, but in which the display structure is generally bowl-shaped.

FIG. 8 is a perspective view of an embodiment similar to that depicted in FIG. 6, but in which the generally cylindrical display structure is elongated in order to facilitate the more vertical display of a text image.

FIG. 9 is a perspective view of a display structure of an embodiment in which the three-dimensional frame is comprised of multiple inflatable sections.

### DETAILED DESCRIPTION OF THE INVENTION

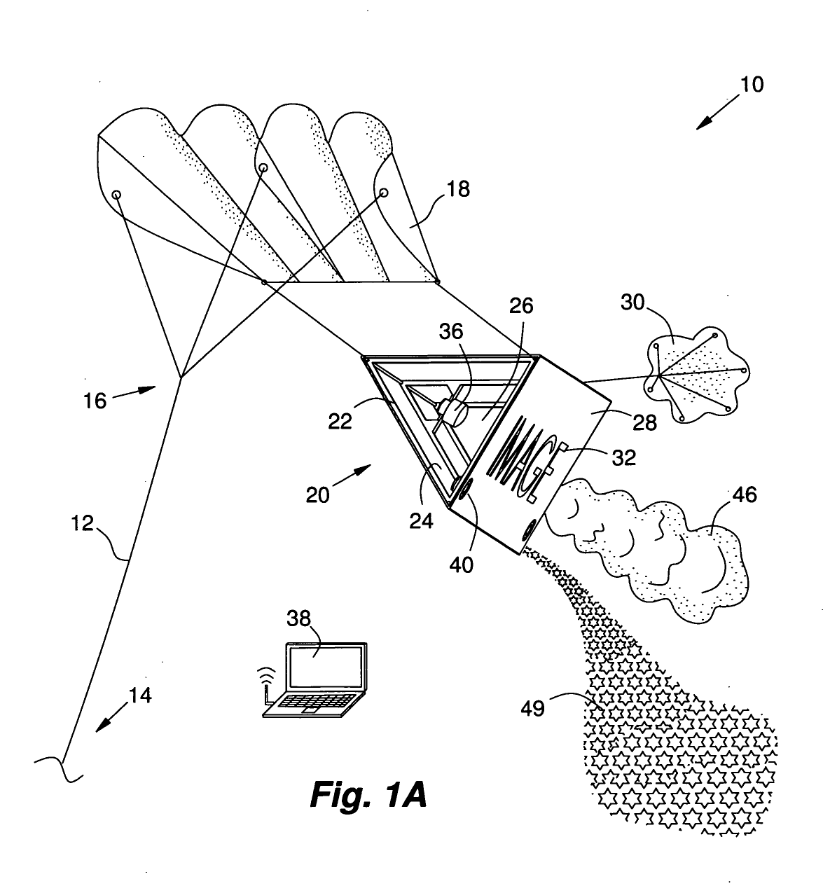

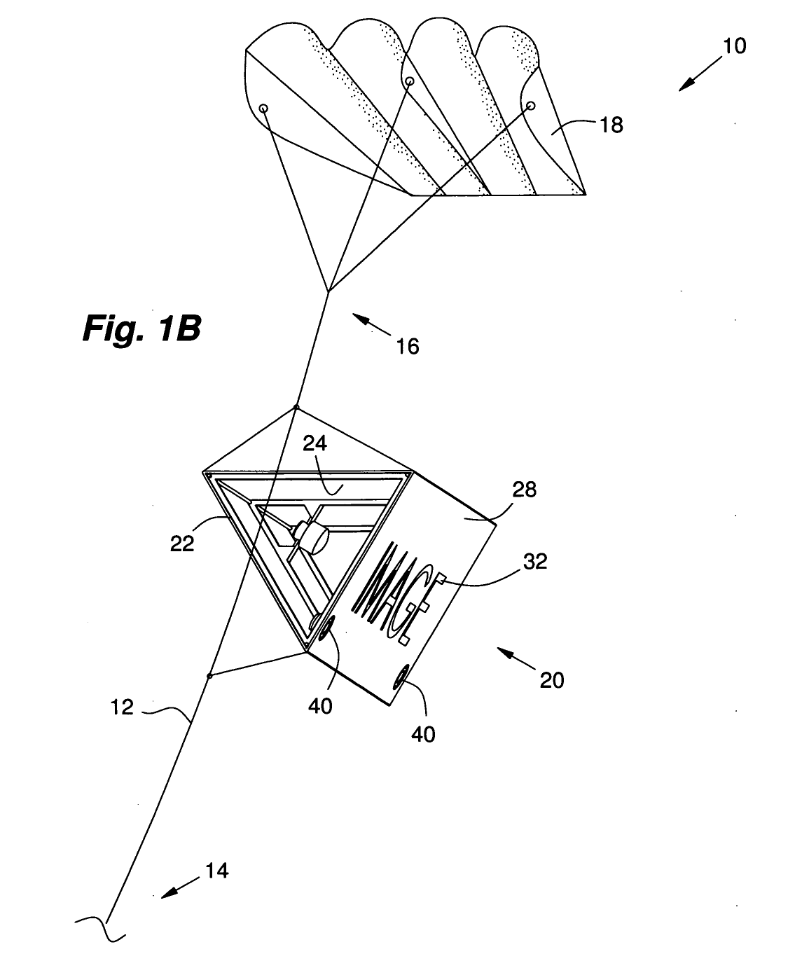

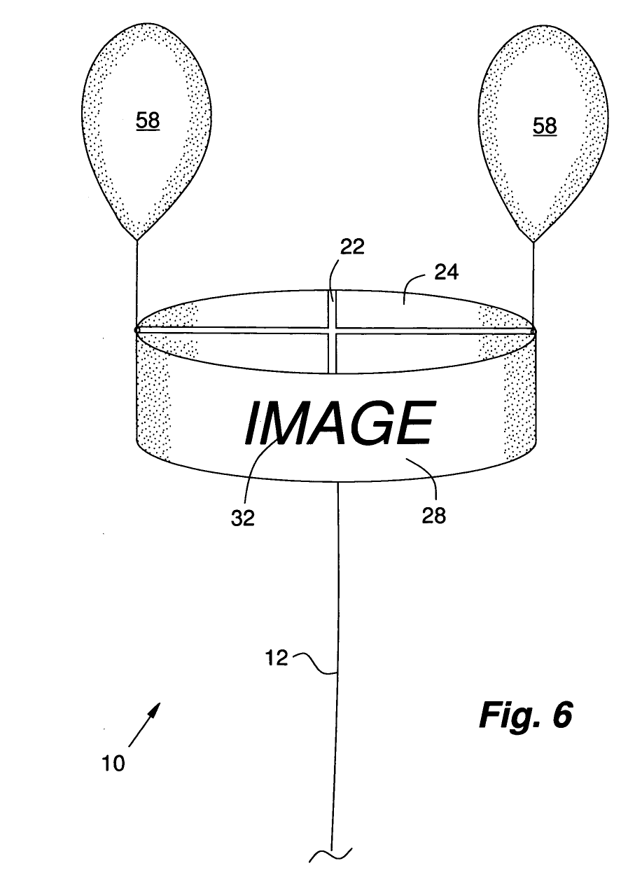

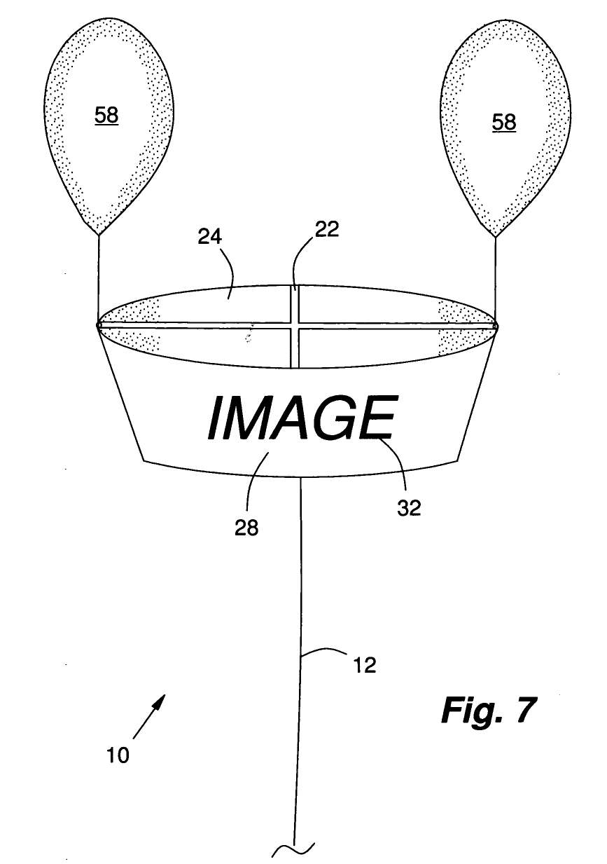

Referring to the drawings, several embodiments of a tether airborne advertising system according to the present invention are shown generally at 10. Turning to FIGS. 1A and 1B for illustration, a tether element 12 has both a proximal end 14 and a distal end 16. Tether element 12 may be made of such materials as cotton, Dacron hemp, Kevlar, Nylon, polyester, or any other line capable of resisting tension loads. A lifting element 18, which may for example be one or more kites, lighter-than-air balloons 58 or a combination thereof, provides a lifting force and is connected to tether element 12 at approximately distal end 16, either directly or by way of, for example, intermediate connective lines (as shown in FIGS. 1A and 1B) or with a display structure 20 disposed between lifting element 18 and distal end 16 (see, for example, FIG. 6). Proximal end 14 is releasably restrained proximate the earth's surface.

As used herein, the term “the earth's surface” is meant to include, for example, the surface of natural and man-made bodies of water, a vehicle thereon, and the top of a building, crane or tower-like structure. Further, as used herein in describing or claiming the present invention, the use of the indefinite article “a” or “an” means “at least one,” and should not be limited to “only one” unless explicitly indicated to the contrary or the context clearly dictates otherwise.

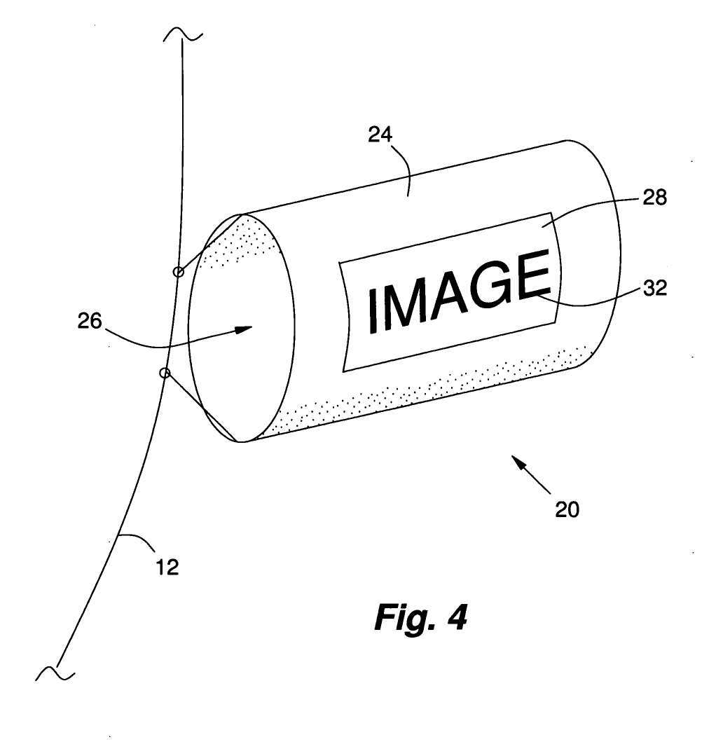

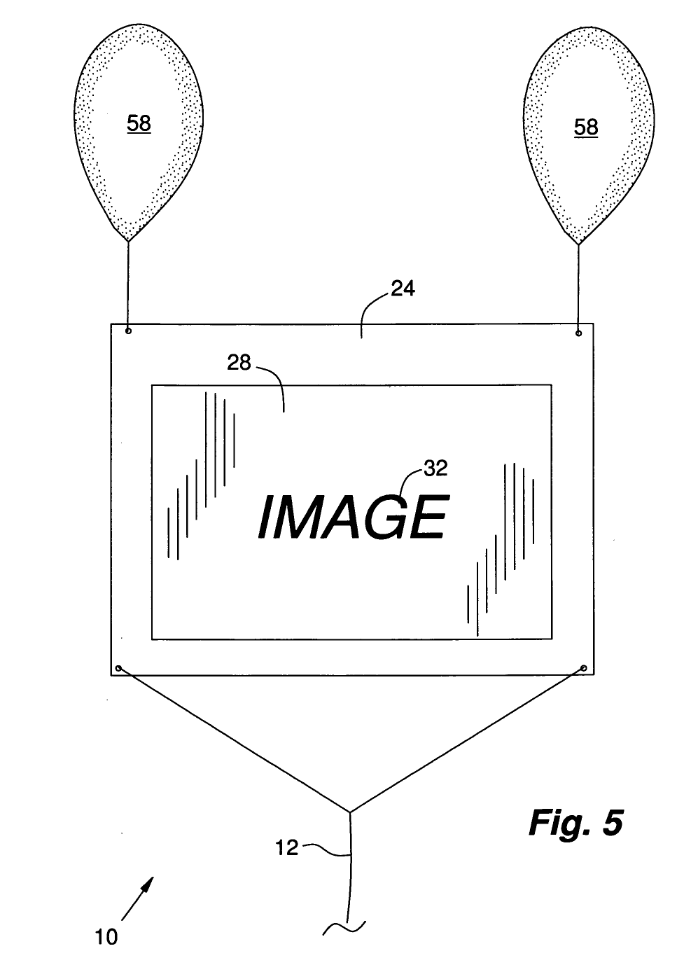

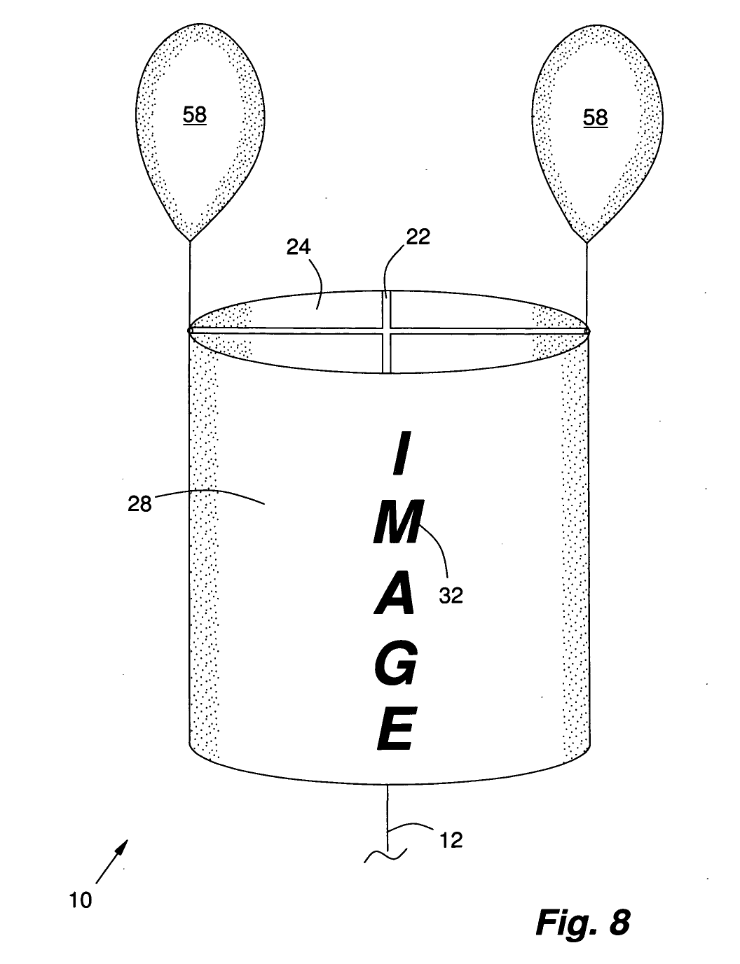

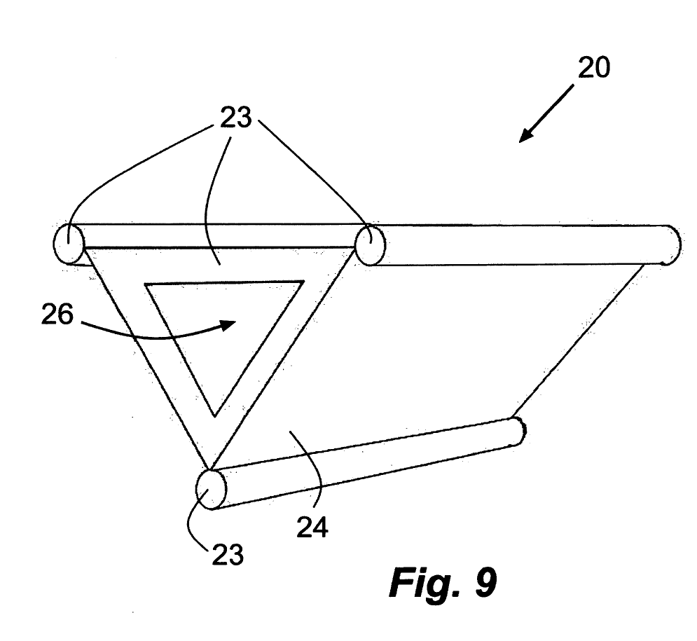

Embodiments include a display structure 20 which typically comprises a three-dimensional frame 22 and a covering 24. Covering 24 cooperates with three-dimensional frame 22 to define an internal compartment 26. Alternatively, embodiments such as that shown in FIG. 5 may comprise a more planar construction. Covering 24 may be made of, for example, paper, light fabrics, ripstop nylon, Styrofoam, etc. Three-dimensional frame 22 may be made of one or a combination of wood, bamboo, plastic, aluminum, carbon composite, rope, string, inflatable sections 23 (see, for example, FIG. 9) or any other lightweight substance suitable to provide a lightweight framework. Three-dimensional frame 22 may, in some embodiments, comprise a single inflatable section 23. In such embodiments, covering 24 may form an integral part of three-dimensional frame 22. In further embodiments, three-dimensional frame 22 may comprise multiple inflatable sections 23 (see, for example, in FIG. 9). Three-dimensional frame 22 is generally adapted to be rapidly assembled and disassembled, or deflated, for ease of portability. Display structure 20 generally forms an open-ended cylindrical construction with one of many cross-sectional shapes, for example, triangular (see FIGS. 1A-3C), square, circular (see, for example, FIGS. 4, 6 and 8). However, display structure 20 may take on other forms as well.

Display structure 20 is adapted to being lifted into an elevated position (as shown, for example, in FIGS. 1A and 1B) primarily by way of the lifting force provided by lifting element 18. However, some embodiments also rely on an auxiliary lifting element 30 in order to maintain an optimal display structure orientation. Auxiliary lifting element 30 may comprise, for example, a small parachute, another kite, another lighter-than-air balloon, or some multiple or combination thereof. In some embodiments, display structure 20 is aerodynamically adapted to help properly orient itself by using the surrounding wind (see, for example, FIG. 1A through FIG. 4). This aerodynamic orientation may be achieved, for example, with an open-end design, in which wind can travel all the way through display structure 20, or with a closed-end design, in which one end of display structure 20 is fully or partially closed to trap wind within internal compartment 26. In embodiments with one or more inflatable sections 23, inflatable sections 23 may be adapted to contain a lighter-than-air fluid. Display structure 20 is generally spatially independent of lifting element 18 when lifting element 18 is in its elevated position.

Display portion 28 is adapted to displaying an image 32 viewable from approximately the earth's surface when display structure 20 is in its elevated position. Display portion 28 is connected to display structure 20, which is intended to mean that display portion 28 can be a separate structure (e.g., a banner) attached to display structure 20 or may be an integral part of display structure 20. Image 32 may be printed on display portion 28, or, for example, projected onto or through display portion 28 (as in, for example, FIG. 1A and 1B).

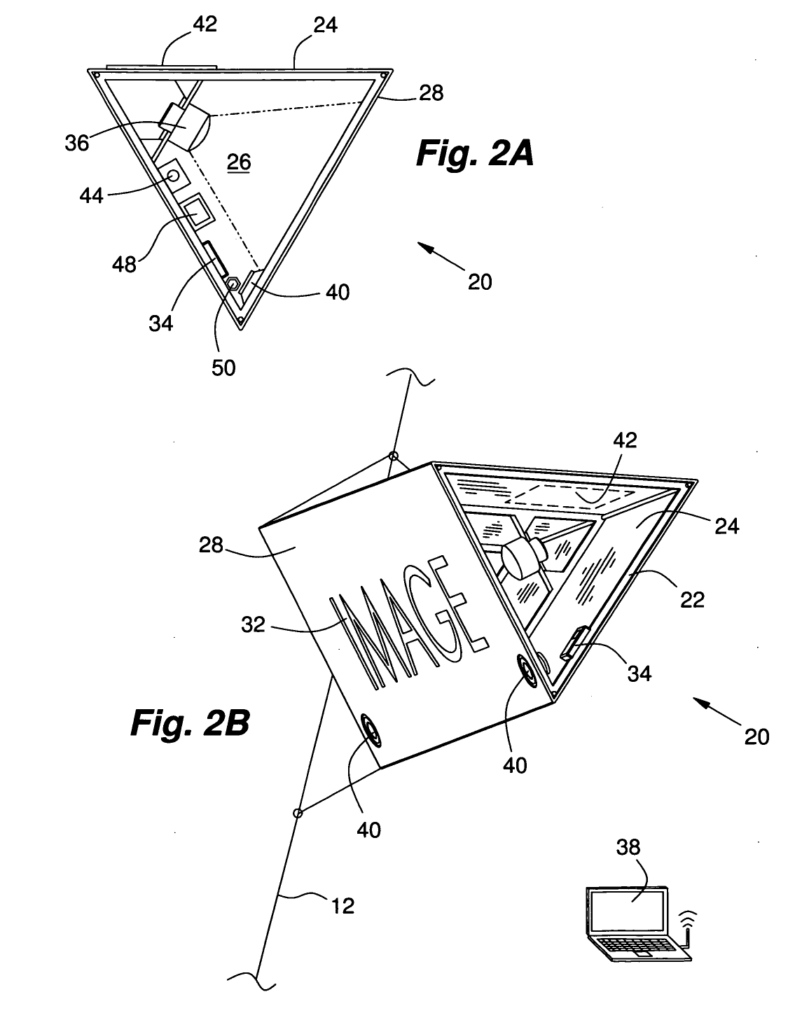

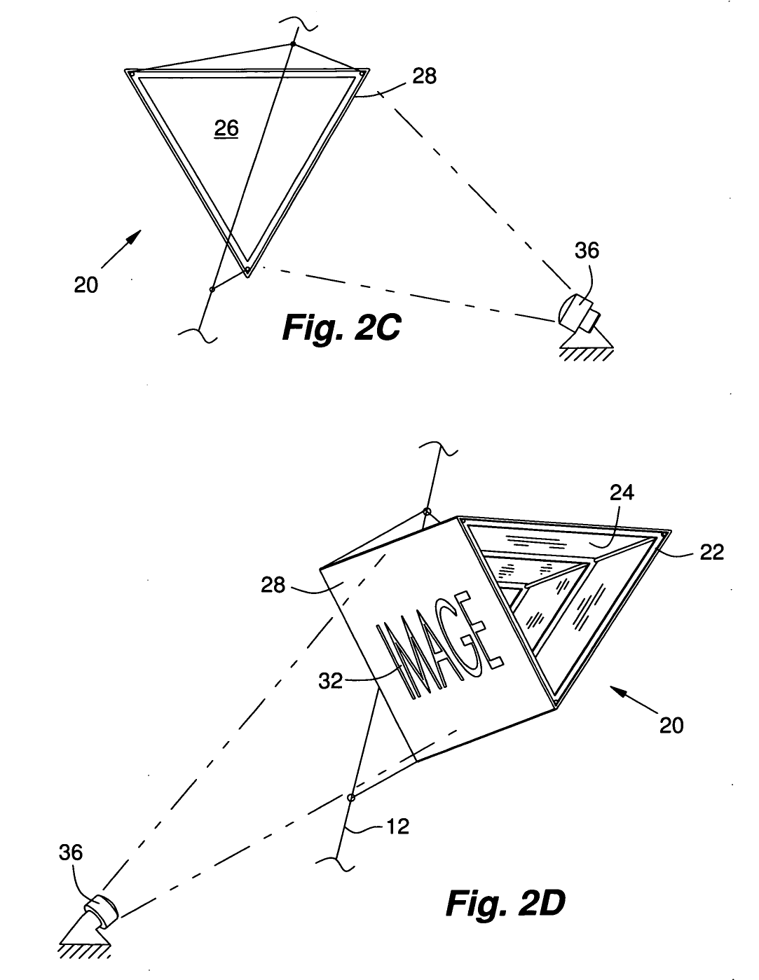

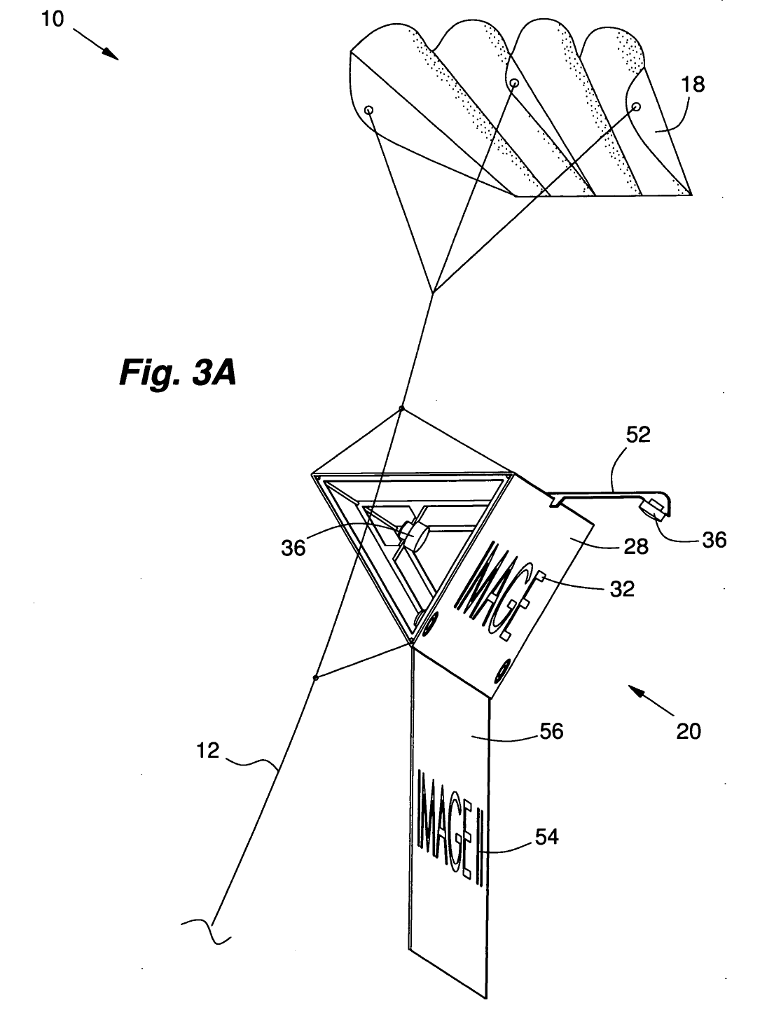

Certain embodiments place image 32 onto display portion 28 by way of a projection subsystem. This projection subsystem typically includes a projector element 36, which may be, for example, a small, lightweight projection camera. In certain embodiments (shown, for example, in FIGS. 2A and 2B) projector element 36 is disposed within internal compartment 26. In other embodiments (see, for example, FIGS. 2C and 2d) projector element 36 is positioned proximate the earth's surface.

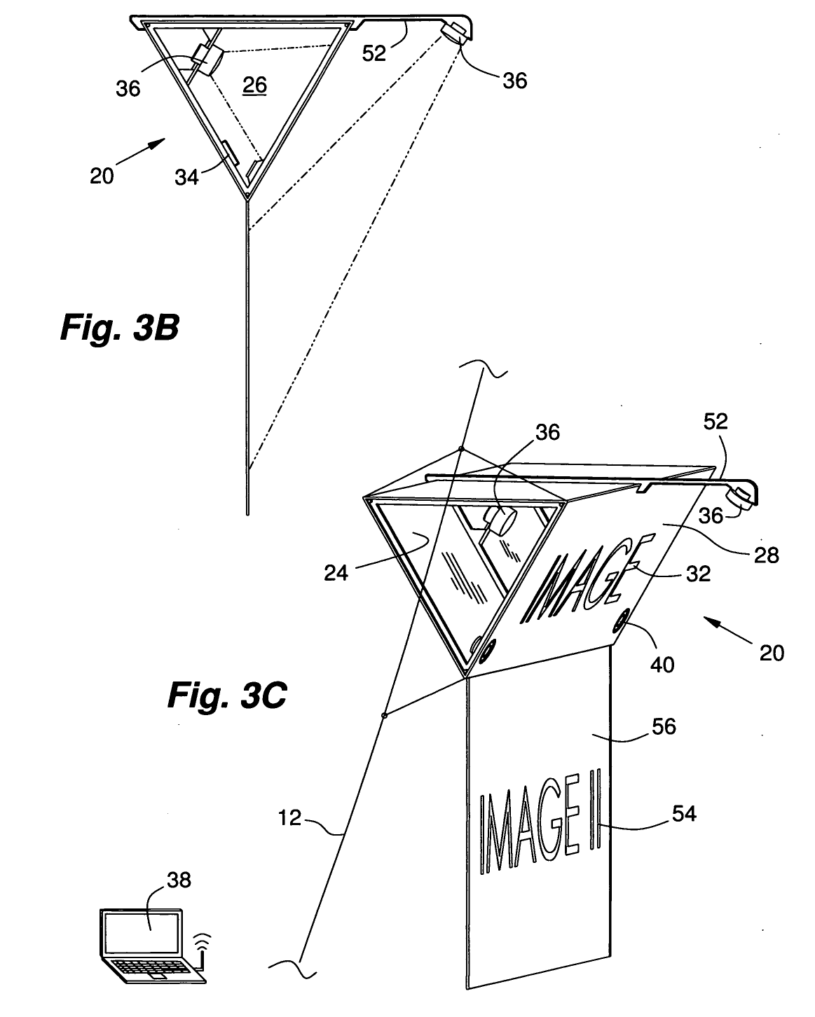

In certain embodiments in which projector element 36 is affixed to display structure 20, projector element 36 may be disposed within internal compartment 26 (see, for example, FIGS. 2A and 2B). In such an embodiment, image 32 would be projected onto the backside of display portion 28, and would be viewable on the opposite side of display portion 28. Turning to FIGS. 3A, 3B and 3C, in other embodiments where projector element 36 is affixed to display structure 20, projector element 36 may be externally mounted to display structure 20 by way of, for example, a mounting boom 52. A second display portion 56 may be connected to display structure 20 to provide a surface on which to project a second image 54. In yet further embodiments, projector elements 36 can be mounted both within internal compartment 26 and externally by way of a mounting boom 52. It is understood that more than one or two projector elements can be included in an embodiment, along with the respectively produced images.

Turning now to FIGS. 2A and 2B for illustration, embodiments may further comprise a signal receiver 34 operably associated with display structure 20, a signal transmitter 38 operably associated with signal receiver 34, and a power source (see, for example, solar panel 42) operably associated with signal receiver 34 for supplying electrical power thereto. The data sent by signal transmitter 38 can, for example, allow a user on the ground to modify image 32 and second image 54 remotely by way of a variety of signal types including RF, IR, copper wire, fiber optics and the like. The power source can be ground-based or, for example, positioned onboard display structure 20. In embodiments equipped with an on-board power source, the power source may take the form, in whole or in part, of one or more solar panels 42, batteries (not shown), or a wind powered generator (not shown).

Referring once again to FIGS. 2A and 2B for illustration, certain embodiments may further comprise an effects interface 50 typically affixed to display structure 20 and adapted to quickly connect and electrically communicate with at least one attention-getting device fixedly associated with display structure 20. Such attention-getting devices may include, for example, a smoke effect device 44, confetti release device 48, flier release device, visual transmission device and sound transmission device 40. In particular embodiments, the function of some or all of these attention-getting devices can be remotely commanded by way of signal transmitter 38. As illustrated in FIG. 1A, the smoke release device 44 is capable of producing smoke effect 46 on command. Similarly, confetti release device 48 is capable of releasing, for example, environmentally friendly confetti into the sky on command.

Sound transmission device 40 can, in some embodiments, be remotely commanded at will to play music, advertising messages or sound effects as directed by a person operating signal transmitter 38. The visual transmission device may in some embodiments be considered to comprise the aforementioned projection subsystem, and in other embodiments comprise, for example, LED displays, pyrotechnics, etc. Similar to sound transmission device 40, the visual transmission device may be remotely commanded to modify the visual effect (e.g., text, graphics, etc.) being emitted. The visual transmission device of some embodiments may also display motion video.

The foregoing detailed description of the invention is intended to be illustrative and is not intended to limit the scope of the invention. Changes and modifications are possible with respect to the embodiments detailed in the foregoing description, and it is understood that the invention may be practiced otherwise than that specifically described herein and still be within the scope of the appended claims.

1. A tethered airborne advertising system operable from a location proximate to the earth's surface, said system comprising:
(a) a tether element having a proximal end and a distal end, said proximal end being releasably restrained proximate the earth's surface;
(b) a lifting element connected to said tether element for providing a lifting force;
(c) a display structure connected to said lifting element, said display structure including a three-dimensional frame and a covering connected to said three-dimensional frame and cooperating therewith to define an internal compartment; and
(d) a display portion connected to said display structure for displaying an image viewable from proximate the earth's surface.

2. The tethered airborne advertising system as defined in claim 1 in which said lifting element is disposed between said tether element and said display structure.

3. The tethered airborne advertising element as defined in claim 1 in which said display structure is disposed between said tether element and said lifting element.

4. The tethered airborne advertising system as defined in claim 1 in which said lifting element comprises a kite.

5. The tethered airborne advertising system as defined in claim 1 in which said lifting element comprises a lighter-than-air balloon.

6. The tethered airborne advertising system as defined in claim 1 in which said three-dimensional frame comprises an inflatable section.

7. The tethered airborne advertising system as defined in claim 1 further comprising a projection subsystem operably associated with said display portion for projecting said image onto said display portion.

8. The tethered airborne advertising system as defined in claim 1 further comprising a projection subsystem for projecting said image onto said display portion, said projection subsystem including a projector element operably affixed to said display structure, said image being projected by said projector element.

9. The tethered airborne advertising system as defined in claim 8 in which said projection system further includes:
(a) a signal receiver operably associated with said display structure and electrically associated with said projector element;
(b) a signal transmitter operably associated with said signal receiver for transmitting to said signal receiver to modify said image; and
(c) a power source operably associated with said signal receiver for supplying electrical power thereto.

10. The tethered airborne advertising system as defined in claim 9 further comprising a sound transmission device operably associated with said display structure for supplying electrical power to said sound transmission device.

11. The tethered airborne advertising system as defined in claim 9 in which said power source comprises a solar panel.

12. The tethered airborne advertising system as defined in claim 9 in which said power source comprises a wind-driven generator.

13. The tethered airborne advertising system as defined in claim 9 further comprising a smoke effect device operably associated with said signal receiver for creating a smoke effect when so commanded by way of said signal receiver.

14. A tethered airborne advertising system operable from a location proximate to the earth's surface, said system comprising:
(a) a tether element having a proximal end and a distal end, said proximal end being releasably restrained proximate the earth's surface;
(b) a lifting element connected to said tether element for providing a lifting force;
(c) a display structure connected to said lifting element;
(d) a display portion connected to said display structure for displaying an image viewable from proximate the earth's surface;
(e) an effects interface for electrically communicating with at least one attention-getting device; and
(f) a power source for providing electrical power to said effects interface.

15. The tethered airborne advertising system as defined in claim 14 further comprising a smoke effect device operably connected to said effects interface and operably associated with said signal receiver for creating a smoke effect when so commanded by way of said signal receiver.

16. The tethered airborne advertising system as defined in claim 14 further comprising a confetti release device operably connected to said effects interface and operably associated with said signal receiver for releasing confetti when so commanded by way of said signal receiver.

17. The tethered airborne advertising system as defined in claim 14 further comprising a flier release device operably connected to said effects interface and operably associated with said signal receiver for releasing printed fliers when so commanded by way of said signal receiver.

18. The tethered airborne advertising system as defined in claim 14 further comprising a sound transmission device operably connected to said effects interface and operably associated with said signal receiver for transmitting sound detectable to the unaided human ear at approximately ground level when so commanded by way of said signal receiver.

19. The tethered airborne advertising system as defined in claim 14 further comprising a visual transmission device operably connected to said effects interface and operably associated with said signal receiver for transmitting a visible signal detectable to the unaided human eye at approximately ground level when so commanded by way of said signal receiver.

20. A tethered airborne advertising system operable from a location proximate to the earth's surface, said system comprising:
(a) a tether element having a proximal end and a distal end, said proximal end being releasably restrained proximate the earth's surface;
(b) a lifting element connected to said tether element for providing a lifting force;
(c) a display structure connected to said lifting element, said display structure including a three-dimensional frame and a covering connected to said three-dimensional frame and cooperating therewith to define an internal compartment;
(d) a display portion connected to said display structure for displaying an image viewable from proximate the earth's surface;
(e) an effects interface for electrically communicating with an attention-getting device;
(f) a power source for providing electrical power to said effects interface;
(g) a signal receiver operably associated with said display structure and electrically associated with said attention-getting device by way of said effects interface; and
(h) a signal transmitter operably associated with said signal receiver for transmitting to said receiver to modify operation of said attention-getting device.
